(19) United States
(12) Patent Application Publication
(10) Pub. No.: US 2022/0134316 A1
(43) Pub. Date: May 5, 2022

(54) Synthesis of high surface area, high entropy oxides

(71) Applicants: National Technology & Engineering Solutions of Sandia, LLC, Albuquerque, NM (US); STC.UNM, Albuquerque, NM (US)

(72) Inventors: Stanley Shihyao Chou, Albuquerque, NM (US); Christopher Ryan Riley, Albuquerque, NM (US); Abhaya Datye, Albuquerque, NM (US); Andrew de la Riva, Albuquerque, NM (US)

(21) Appl. No.: 17/087,938

(22) Filed: Nov. 3, 2020

(51) Int. Cl. B01J 23/83; C01F 17/241; C01G 49/00; C01G 45/12; B01J 23/10; B01J 23/34; B01J 35/10; C01B 32/50; B01J 37/04; B01J 37/00; B01J 37/03; B01J 37/02; B01J 37/08

(52) U.S. Cl. CPC B01J 23/83; C01P 2006/12; C01G 49/0054; C01G 45/1228; B01J 23/10; B01J 23/34; B01J 35/1009; C01B 32/50; B01J 37/04; B01J 37/0018; B01J 37/036; B01J 37/0236; B01J 37/088; C01P 2002/50; C01P 2002/30; C01F 17/241

(57) ABSTRACT

High surface area, high entropy oxides comprising multiple metal cations in a single-phase fluorite lattice material enables intrinsic catalytic activity without platinum group metals, tunable oxygen storage capacity, and thermal stability. These properties can be obtained through a facile sol-gel synthesis to provide a low-temperature route for production of phase-pure multi-cationic oxides. The resulting materials achieved significantly higher surface area and catalytic performance, taking advantage of all the properties endowed by the various cations in the composition.

### STATEMENT OF GOVERNMENT INTEREST

This invention was made with Government support under Contract No. DE-NA0003525 awarded by the United States Department of Energy/National Nuclear Security Administration. The Government has certain rights in the invention.

### FIELD OF THE INVENTION

The present invention relates to catalysts and, in particular, to high surface area, high entropy oxides that can be effective catalysts for CO oxidation.

### BACKGROUND OF THE INVENTION

High entropy oxides (HEOs) are oxide counterparts to high entropy alloys. See C. M. Rost et al., Nat. Commun. 6, 8485 (2015). HEOs contain multiple cations (typically five or more), with some if not all occupying equivalent lattice sites within a single-phased structure. The multiple cations, which individually may phase segregate and form binary oxides of dissimilar crystal structure, are instead stabilized within a single phase through an increase in configurational entropy. This reduces Gibbs free energy, particularly at high temperatures. As such, HEOs are thermally robust, complex materials with an enormous number of unique compositions available for study. Previous work applied the HEO concept by incorporating multiple cations into single-phase rock salt, perovskite, spinel, and fluorite structures. See C. M. Rost et al., Nat. Commun. 6, 8485 (2015); H. Chen et al., J. Mater. Chem. A 6(24), 11129 (2018); A. Sarkar et al., Nat. Commun. 9(1), 3400 (2018); A. Sarkar et al., J. Eur. Ceram. Soc. 38(5), 2318 (2018); F. Okejiri et al., ChemSusChem 13(1), 111 (2020); D. Wang et al., J. Mater. Chem. A 7(42), 24211 (2019); J. Gild et al., J. Eur. Ceram. Soc. 38(10), 3578 (2018); R. Djenadic et al., Mater. Res. Lett. 5(2), 102 (2016); M. R. Chellali et al., Scr. Mater. 166, 58 (2019); J. Dqbrowa et al., J. Eur. Ceram. Soc. 40(15), 5870 (2020); A. J. Wright et al., J. Eur. Ceram. Soc. 40(5), 2120 (2020); and L. Spiridigliozzi et al., Materials (Basel) 13(3), 558 (2020). The resulting HEO materials show impressive properties, including exceptionally high dielectric constants, ionic storage capacity, and low thermal conductivities. See D. Bérardan et al., J. Mater. Chem. A 4(24), 9536 (2016); A. Sarkar et al., Nat. Commun. 9(1), 3400 (2018); J. Gild et al., J. Eur. Ceram. Soc. 38(10), 3578 (2018); A. J. Wright et al., J. Eur. Ceram. Soc. 40(5), 2120 (2020); and K. Chen et al., J. Eur. Ceram. Soc. 38(11), 4161 (2018). However, the potential of HEOs as heterogeneous catalysts for gas-phase reactions remains largely untapped. This is partly due to the nascency of the HEO field and of conventional synthesis techniques, which are ill-suited for producing active catalysts.

In particular, there is a need for effective catalysts for CO oxidation. This oxidation reaction is performed by automotive catalysts to curb CO emissions generated during combustion of hydrocarbon fuel. Desirable properties of such catalysts include lower conversion temperatures, use of inexpensive materials, ease of synthesis, and thermal stability. Previous attempts to use HEOs as CO oxidation catalysts have yielded low intrinsic activities due to conventional high-temperature solid-state syntheses and the use of crystal structures and constituent elements that are unoptimized for gas-phase oxidation reactions. Chen et al. produced rock salt type-HEOs through 900° C. synthesis. These showed low surface areas (2-28 m²/g), and the addition of Pt was required to improve the low oxidation activity. See H. Chen et al., J. Mater. Chem. A 6(24), 11129 (2018). Okejiri et al. demonstrated improved surface area (86 m²/g) in a perovskite-type HEO, yet the HEO lacked activity without Ru addition. See F. Okejiri et al., ChemSusChem 13(1), 111 (2020). Lastly, Chen et al. achieved good activity without the use of platinum group metals (PGMs) in a doped ceria-HEO hybrid. However, the rock salt-type HEO itself was not catalytically active. See H. Chen et al., Appl. Catal. B 276, 119155 (2020). Overall, the conventional use of high-temperature processes (often ≥1000° C.) to achieve HEO structures is counterproductive for catalysis applications. See H. Chen et al., J. Mater. Chem. A 6(24), 11129 (2018); and H. Chen et al., Appl. Catal. B 276, 119155 (2020). These synthesis conditions cause significant surface area and oxygen storage capacity (OSC) loss, which lowers oxidation activity. See J. Guo et al., J. Alloys Compd. 621, 104 (2015); B. Zhao et al., J. Environ. Chem. Eng. 1(3), 534 (2013); and P. Li et al., Catal. Today 327, 90 (2019). Further, it is unclear whether the surface area and redox properties of rock salt and perovskite-type HEOs to date can rival those of conventional ceria-zirconia solid solutions having a fluorite structure. See P. Li et al., Catal. Today 327, 90 (2019); and C. Riley et al., Appl. Catal. B 264, 118547 (2020). However, fluorite-type HEOs thus far have been made solely through high-temperature means and evaluated for noncatalytic properties (entropy stabilization, thermal and electrical conductivities, hardness, and densification). See J. Gild et al., J. Eur. Ceram. Soc. 38(10), 3578 (2018); R. Djenadic et al., Mater. Res. Lett. 5(2), 102 (2016); M. R. Chellali et al., Scr. Mater. 166, 58 (2019); J. Dąbrowa et al., J. Eur. Ceram. Soc. 40(15), 5870 (2020); A. J. Wright et al., J. Eur. Ceram. Soc. 40(5), 2120 (2020); L. Spiridigliozzi et al., Materials (Basel) 13(3), 558 (2020); K. Chen et al., J. Eur. Ceram. Soc. 38(11), 4161 (2018); and H. Chen et al., Appl. Catal. B 276, 119155 (2020).

### SUMMARY OF THE INVENTION

The present invention is directed to a high surface area, high entropy oxide (HEO), comprising a plurality of metal cations with oxygen anions in a single-phase fluorite lattice structure, wherein at least one of the metal cations comprises a first-row transition metal cation. The plurality of metal cations can comprise five or more metal cations, including, for example, Ce, Al, La, Nd, Pr, Sm, Y, or Zr. For example, the first-row transition metal cation can comprise Fe or Mn.

The HEO can be synthesized using a sol-gel method, providing a high surface area. Therefore, the invention is further directed to a method for the sol-gel synthesis of a high surface area, high entropy oxide, comprising dissolving a polymeric complexing agent in water, thereby providing an aqueous solution, dissolving a plurality of metal salts in the aqueous solution, thereby complexing the dissolved metal cations with a functional group of the polymeric complexing agent in the aqueous solution, drying the aqueous solution to form a gel, and calcining the gel in an oxygen atmosphere to provide the high surface area, high entropy oxide in a single-phase fluorite lattice structure. For example, the polymeric complexing agent can comprise polyvinylpyrrolidone. The gel can be calcined at a relatively low temperature (e.g., about 500° C., +/−50° C.)

Finally, the invention is further directed to a method for the oxidation of CO, comprising providing a high surface area, high entropy oxide, and exposing the high-surface area, high entropy oxide to gaseous CO, thereby catalyzing the conversion of CO to CO₂.

The chemical complexity of single-phase multi-cationic high entropy oxides enables the integration of conventionally incompatible metal cations into a single crystalline phase. According to the invention, the HEO concept is applied to design robust catalysts in which the multi-cationic oxide composition is tailored to achieve simultaneous functionalities, including catalytic activity, oxygen storage capacity, and thermal stability. Unlike conventional catalysts, these HEOs maintain single phase structure, even at high temperature, and do not rely on addition of expensive platinum group metals (PGM) to be active. The HEOs can be synthesized through a facile, relatively low-temperature (500° C.) sol-gel method, which avoids excessive sintering and catalyst deactivation. As examples of the invention, HEOs comprising Ce in varying concentrations, as well as four other metals among Al, Fe, La, Mn, Nd, Pr, Sm, Y, and Zr were synthesized. All samples adopted a fluorite structure. Oxides with surface areas as high as 138 m²/g were produced, marking a significant structural improvement over previously reported HEOs. First row transition metal cations were most effective at improving CO oxidation activity, but their incorporation reduces thermal stability. Rare earth cations can prevent thermal deactivation while maintaining activity. The invention demonstrates the utility of entropy in complex oxide design, and a low-energy synthetic route to produce HEOs with cations selected for a cooperative effect toward robust performance in chemically and physically demanding applications.

### BRIEF DESCRIPTION OF THE DRAWINGS

The detailed description will refer to the following drawings, wherein like elements are referred to by like numbers.

FIG. 1 shows X-ray diffraction (XRD) patterns of sol-gel prepared Ceₓ(LaPrSmY)₁₋ₓO_{2-y} samples with varying Ce content.

FIG. 2 shows Attenuated Total Reflectance Fourier Transform Infrared (ATR-FTIR) spectra of powders made through evaporation of solutions containing dissolved polyvinylpyrrolidone (PVP) only and PVP plus a nitrate of Ce, La, Nd, Pr, and Sm.

FIG. 3 is an XRD pattern of the dried precursor gel of a (CeLaNdPrSm)O_{2-y} sample.

FIG. 4 shows SEM-EDS elemental mappings of the (CeLaPrSmY)O_{2-y} sol-gel sample.

FIG. 5 shows specific surface areas of HEO sol-gel samples as a function of cerium content.

FIG. 6 is a graph of CO oxidation activity of (CeLaPrSmY)O_{2-y} solid-state and sol-gel samples and of a CeO₂ sol-gel sample with corresponding specific surface areas listed.

FIGS. 7A and 7B are graph of CO oxidation activity for Ceₓ(FeLaNdZr)₁₋ₓ O_{2-y} and Ceₓ(LaMnNdZr)₁₋ₓO_{2-y} sol-gel samples, respectively. FIGS. 7C and 7D are Arrhenius plots for Ceₓ(FeLaNdZr)₁₋ₓO_{2-y} and Ceₓ(LaMnNdZr)₁₋ₓO_{2-y} sol-gel samples, respectively. FIGS. 7E and 7F are graphs of specific rates for Ceₓ(FeLaNdZr)₁₋ₓO_{2-y} and Ceₓ(LaMnNdZr)₁₋ₓO_{2-y} sol-gel samples, respectively.

FIG. 8 is a graph of CO oxidation activity for Ce_{0.8}(LaMnNdZr)_{0.2}O_{2-y} samples made via sol-gel and physical mixing techniques.

FIG. 9 is a graph of CO oxidation activity for Mn-doped ceria sol-gel samples with and without the inclusion of stabilizing cations before and after aging.

### DETAILED DESCRIPTION OF THE INVENTION

The present invention is directed to PGM-free fluorite-type HEOs with high surface area as competitive oxidation catalysts. A relatively low-temperature (500° C.) sol-gel synthesis can be used to produce the fluorite-type HEOs. In this synthesis, metal cations are mixed in an aqueous solution and bound with a polymeric complexing agent (e.g., polyvinylpyrrolidone) to prevent recrystallization and phase segregation. The synthesis is effective for production of homogeneously doped ceria with high surface areas (up to 179 m²/g). See C. Riley et al., Appl. Catal. B 264, 118547 (2020); C. Riley et al., ChemCatChem 11(5), 1526 (2019). While pure ceria is not particularly active, introducing additional metal cations greatly enhances catalytic performance through a Mars van Krevelen reaction mechanism. See H. Chen et al., Appl. Catal. B 276, 119155 (2020); C. Riley et al., Appl. Catal. B 264, 118547 (2020); and A. Singhania et al., Ind. Eng. Chem. Res. 56(46), 13594 (2017). Metal cations having dissimilar ionic radii and charge from the substituted Ce⁴⁺ ions disrupt the ceria lattice. Lattice oxygen is destabilized as a result and reacts more readily with CO. See C. Riley et al., Appl. Catal. B 264, 118547 (2020); and O. H. Laguna et al., Appl. Catal. B 106(3-4), 621 (2011).

According to the present invention, multiple metal cations are incorporated into a host fluorite lattice, particularly cations belonging to different periodic groups and in varying concentrations. In doing so, the HEO structure can be fine-tuned to achieve high surface area, thermal stability, and oxygen storage capacity (OSC). Incorporation of multiple cations into a parent HEO affords simultaneous functionalities, resulting in improved catalyst design. In particular, high surface area, PGM-free and thermally stable HEOs were developed for catalytic oxidation. This was accomplished through systematic evaluation of a series of HEOs using a Ce-based fluorite phase as the host lattice. The fluorite structure was modified through addition of cationic elements, including Al, Fe, La, Mn, Nd, Pr, Sm, Y, and Zr. These elements were added to improve the oxidation activity, redox properties, and thermal stability of ceria. See C. Riley et al., Appl. Catal. B 264, 118547 (2020); A. Singhania et al., Ind. Eng. Chem. Res. 56(46), 13594 (2017); J. L. Braun et al., Adv. Mater. 30(51), 1805004 (2018); and Dong et al., Nanoscale Res. Lett. 7, 542 (2012). The cerium composition was varied from 20-80 at % while maintaining nominal equimolar concentrations of the other constituent elements. An HEO of (CeLaPrSmY)O_{2-y} composition was initially evaluated. See R. Djenadic et al., Mater. Res. Lett. 5(2), 102 (2016). The composition was then varied to affect catalytic performance. Characterization of this initial sample, made via sol-gel synthesis, was performed to verify phase purity and improvement in surface area, after which four more sets of HEOs having different combinations of constituent elements were produced. CO oxidation activity was found to depend on synthesis method and composition. Careful choice of the multi-cationic oxide phase, composition, and synthesis yielded active heterogeneous catalysts for gas phase reactions without use of PGM or energy-intensive methods.

High surface area HEOs were synthesized using a solution-based sol-gel method involving dissolution of metal salts in the presence of a polymeric complexing agent and subsequent calcination at relatively low temperatures. As an example, the sol-gel synthesis began with dissolution of 5 g of polyvinylpyrrolidone (PVP, average molecular weight=40,000) in 100 ml of deionized water with vigorous stirring. For each sol-gel sample, a total of 10 mmol of metal cations were added to the PVP solution and stirred for 1 hour. The solution was dried at 110° C. to form a hard gel, which was crushed to a coarse powder and calcined in a box furnace for 2 hours at 500° C., with a 1° C./min ramp rate to yield the sol-gel samples. Conventional HEOs were prepared by physically mixing constituent binary metal oxides and heating the mixture at high temperatures to allow interdiffusion and formation of a single-phase oxide. See C. M. Rost et al., Nat. Commun. 6, 8485 (2015); and J. Gild et al., J. Eur. Ceram. Soc. 38(10), 3578 (2018). As an example, appropriate amounts of each oxide were thoroughly mixed with a mortar and pestle and the mixture was heated in a box furnace to 1100° C. for 2 hours. These physically mixed samples were used as low surface area references. Each binary metal oxide was made by heating individual metal precursors in a box furnace to 500° C. for 2 hours. Metal precursors included cerium (III) nitrate hexahydrate, lanthanum (III) nitrate hexahydrate, neodymium (III) nitrate hexahydrate, praseodymium (III) nitrate hexahydrate, samarium (III) nitrate hexahydrate, yttrium (III) acetate hydrate, zirconium acetate solution, aluminum (III) nitrate nonahydrate, ferric nitrate nonahydrate, and manganese (II) nitrate tetrahydrate. Samples are designated hereafter according to their synthesis method as “sol-gel” or “solid state” whenever the two syntheses are compared.

As shown in Table 1, compositions measured by X-ray fluorescence (XRF) were close to nominal values. Each HEO contained Ce and four other cation constituents. For each set of constituent elements, three sample compositions were made by varying the Ce content (20, 50, and 80 at %) and keeping equimolar concentrations of the other four elements. HEOs were labeled according to their nominal compositions, with equimolar elements set in parentheses. Atomic ratio of total cations to oxygen is assumed to be approximately 1:2, given that the samples adopt a fluorite crystal structure, wherein the oxygen anions occupy the eight tetrahedral interstitial sites and the metal cations occupy the regular sites of a face-centered cubic (FCC) structure. However, aliovalent cations can lower oxygen concentration through vacancy formation, which is represented by “y” in the oxygen stoichiometry (O_{2-y}).

TABLE I
XRF compositional analysis of samples.

| | Measured composition (at %) | | | | |
|---|---|---|---|---|---|
| Sol-gel sample | Ce | La | Pr | Sm | Y |
| (CeLaPrSmY)O_{2-y} | 19.6 | 19.3 | 20.6 | 17.7 | 22.9 |
| Ce_{0.5}(LaPrSmY)_{0.5}O_{2-y} | 49.3 | 12.2 | 12.5 | 9.2 | 16.8 |
| Ce_{0.8}(LaPrSmY)_{0.2}O_{2-y} | 77.8 | 5.8 | 5.8 | 5.1 | 5.6 |
| | Ce | La | Nd | Pr | Sm |
| (CeLaNdPrSm)O_{2-y} | 19.3 | 20.8 | 21.4 | 21.8 | 16.8 |
| Ce_{0.5}(LaNdPrSm)_{0.5}O_{2-y} | 53.4 | 11.3 | 14.7 | 11.6 | 9.1 |
| Ce_{0.8}(LaNdPrSm)_{0.2}O_{2-y} | 76.0 | 5.7 | 10.2 | 5.1 | 3.0 |
| | Ce | Al | Pr | Y | Zr |
| (CeAlPrYZr)O_{2-y} | 17.9 | 11.5 | 18.1 | 23.3 | 29.3 |
| Ce_{0.5}(AlPrYZr)_{0.5}O_{2-y} | 47.7 | 10.0 | 12.4 | 20.1 | 9.8 |
| Ce_{0.8}(AlPrYZr)_{0.2}O_{2-y} | 75.8 | 3.9 | 6.2 | 8.6 | 5.4 |
| | Ce | Fe | La | Nd | Zr |
| (CeFeLaNdZr)O_{2-y} | 20.8 | 20.0 | 22.1 | 22.3 | 14.8 |
| Ce_{0.5}(FeLaNdZr)_{0.5}O_{2-y} | 49.4 | 13.3 | 9.8 | 15.8 | 11.7 |
| Ce_{0.8}(FeLaNdZr)_{0.2}O_{2-y} | 74.6 | 5.6 | 5.3 | 8.9 | 5.6 |
| | Ce | La | Mn | Nd | Zr |
| (CeLaMnNdZr)O_{2-y} | 21.4 | 22.8 | 16.3 | 22.9 | 16.7 |
| Ce_{0.5}(LaMnNdZr)O_{2-y} | 47.7 | 12.6 | 8.1 | 15.3 | 15.3 |
| Ce_{0.8}(LaMnNdZr)_{0.2}O_{2-y} | 76.6 | 5.7 | 4.7 | 5.7 | 7.3 |
| | Ce | Fe | Mn | | |
| Ce_{0.9}Fe_{0.1}O_{2-y} | 89.5 | 10.5 | — | | |
| Ce_{0.9}Mn_{0.1}O_{2-y} | 90.6 | — | 9.4 | | |
| Solid State | Measured composition (at %) | | | | |
| Sample | Ce | La | Pr | Sm | Y |
| (CeLaPrSmY)O_{2-y} | 20.5 | 18.4 | 22.1 | 23.2 | 15.8 |
| | Ce | La | Mn | Nd | Zr |
| Ce_{0.8}(LaMnNdZr)_{0.2}O_{2-y} | 75.5 | 5.8 | 2.5 | 11.0 | 5.2 |

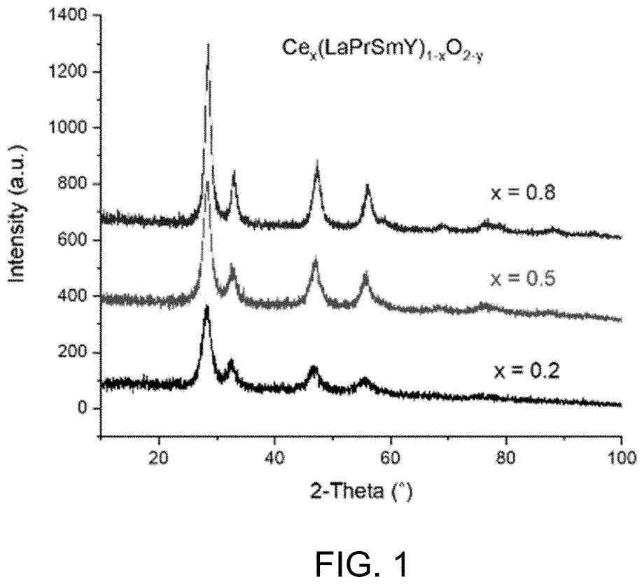

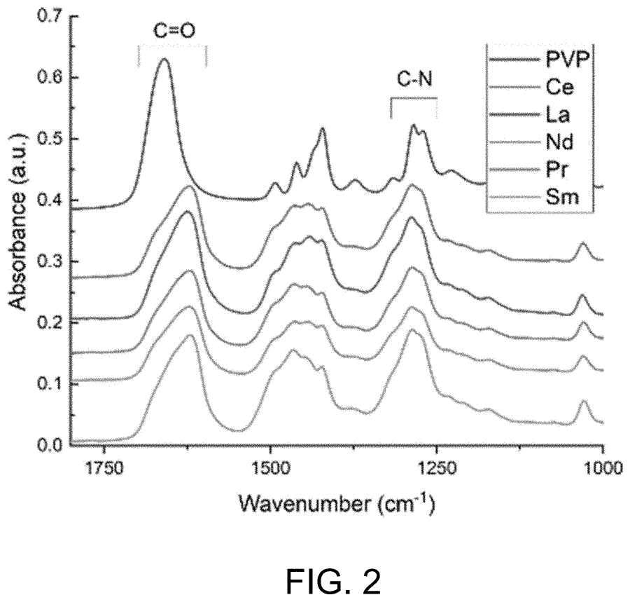

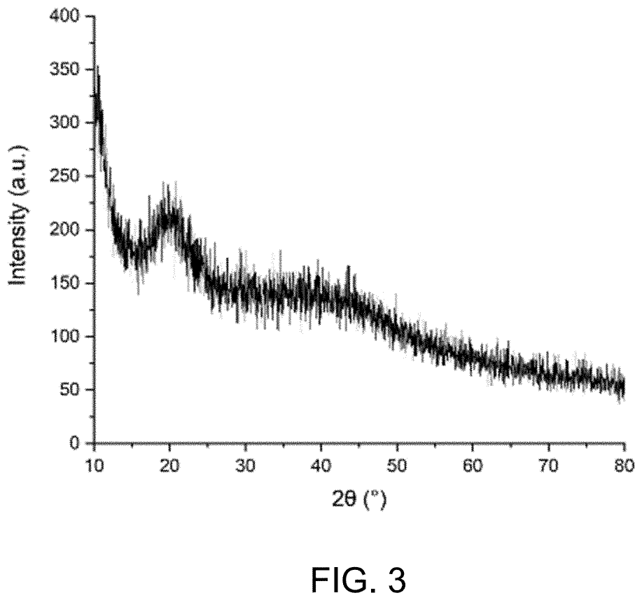

The structure of the (CeLaPrSmY)O_{2-y} samples made with both the solid state and sol-gel synthetic methods was determined. X-ray diffraction (XRD) spectra of the sol-gel samples, shown in FIG. 1, indicate that the sol-gel method produced a phase-pure material with fluorite structure and nanoscale particle size. On the other hand, slight phase segregation was found in the (CeLaPrSmY)O_{2-y} sample made with the solid-state synthesis. These results demonstrate the utility of the sol-gel method for producing single-phase HEOs at reduced temperatures. Given the lower synthesis temperature of the sol-gel sample, smaller crystallite sizes result, leading to peak broadening. Peaks corresponding to high index planes beyond (311) show low intensity or are unidentifiable. The (CeLaPrSmY)O_{2-y} sol-gel sample was additionally aged at 800° C. to enhance detectability of any segregated phases. No other phases were detected after aging. Chellali et al. previously observed sample homogeneity in HEOs with this composition made via high temperature synthesis. See M. R. Chellali et al., Scr. Mater. 166, 58 (2019). Achievement of phase purity at lower temperatures using the sol-gel method is attributed to the increased diffusion rates of cations in solution, which are multiple orders of magnitude greater than diffusion rates in the solid state. As such, cations were able to mix uniformly prior to calcination using the sol-gel method. Compositional uniformity was maintained through complexation of metal ions to PVP functional groups within solution, which prevents their recrystallization during the drying step. Fourier Transform Infrared (FTIR) and XRD analyses provide evidence of this phenomenon. Attenuated Total Reflectance (ATR) FTIR spectra were taken on powdered gels made by drying solutions of PVP and individual metal precursors, including those of Ce, La, Nd, Pr, and Sm. As shown in FIG. 2, ATR-FTIR spectra of the precursor powders show a shift and broadening of peaks corresponding to C═O and C—N vibrations, which suggests bonding of the metal ions to these functional groups. An XRD pattern of the powdered gel precursor of the (CeLaNdPrSm)O_{2-y}, shown in FIG. 3, indicates an absence of any recrystallized phases, only a broad peak corresponding to the amorphous polymer network. PVP was thus effective at maintaining compositional uniformity during sol-gel synthesis.

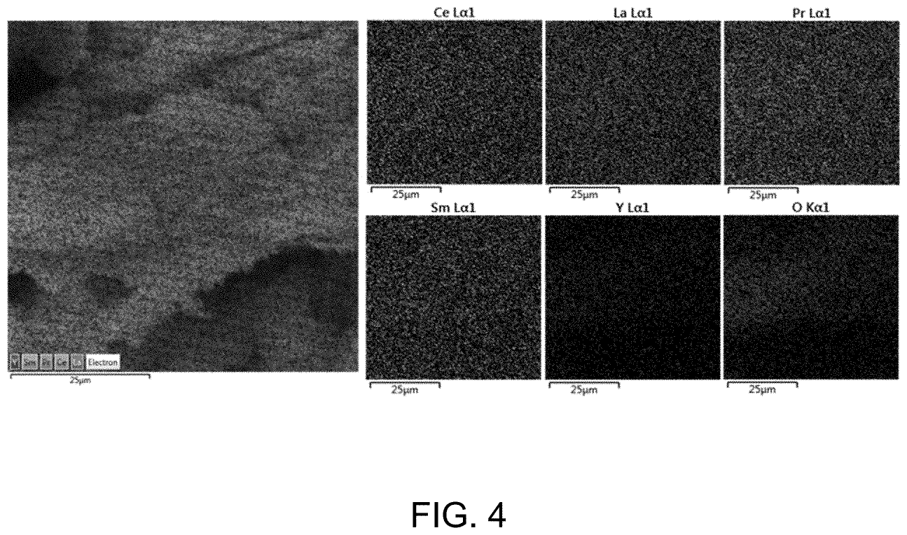

Having achieved phase purity in the equimolar (CeLaPrSmY)O_{2-y} sol-gel sample, XRD analysis was extended to Ce_{0.5}(LaPrSmY)_{0.5}O_{2-y} and Ce_{0.8}(LaPrSmY)_{0.2}O_{2-y}. As shown in FIG. 1, phase purity was maintained in Ce-rich samples. SEM-EDS mapping of the equimolar sample, shown in FIG. 4, further confirms compositional uniformity. Similar uniform maps were obtained for HEOs containing other constituent elements made via sol-gel and solid-state syntheses. XRD analysis of Ceₓ(LaNdPrSm)₁₋ₓO_{2-y}, Ceₓ(AlPrYZr)₁₋ₓO_{2-y}, Ceₓ(FeLaNdZr)₁₋ₓO_{2-y}, and Ceₓ(LaMnNdZr)₁₋ₓO_{2-y} sol-gel samples similarly found only the presence of a single crystalline fluorite phase. These results agree with those of Djenadic et al, which concluded that Ce inclusion was key to producing phase pure fluorite-type HEOs. See R. Djenadic et al., Mater. Res. Lett. 5(2), 102 (2016). Increasing cerium content improved crystallinity among all sample compositions studied. Given the fluorite-type parent lattice of these oxides, this effect is expected. Of the equimolar samples, those containing Al, Fe, and Mn showed rather poor crystallinity, to the extent that neighboring (111) and (200) peaks become nearly indistinguishable. Incorporation of relatively small Al, Fe, and Mn cations into the Ce-based fluorite lattice is expected to cause significant lattice strain.

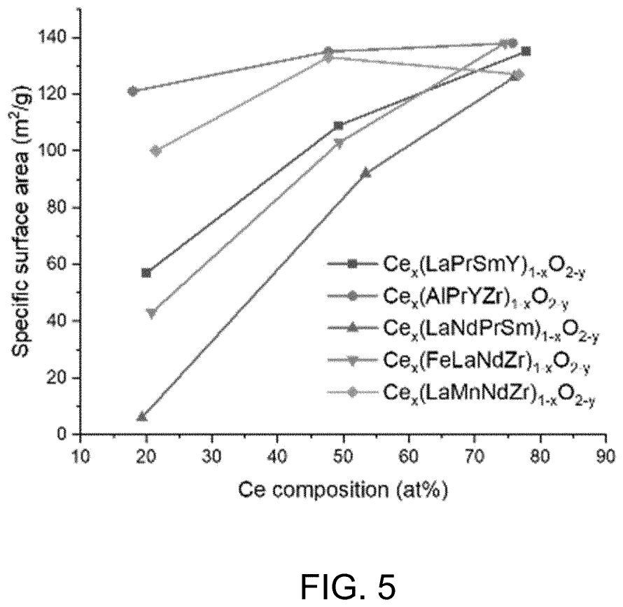

Specific surface area was determined via Brunauer Emmett Teller (BET) analysis. The surface area of the sol-gel (CeLaPrSmY)O_{2-y} sample far exceeds that of the solid-state sample, which were 57 and 3 m²/g, respectively. Surface area results for all HEO sol-gel samples in as-prepared condition are plotted in FIG. 5 as a function of XRF-measured Ce content. Values ranged from 6-138 m²/g. Except for one sample, Ce_{0.8}(LaMnNdZr)_{0.2}O_{2-y}, surface area increased with cerium content in all material systems studied. However, the dependence of surface area on cerium content varied widely among the sets of constituent elements. With nominal cerium content ranging from 20-80 at %, surface area of the Ceₓ(LaNdPrSm)₁₋ₓO_{2-y} system changed dramatically (6-126 m²/g). Ceₓ(LaPrSmY)₁₋ₓO_{2-y} and Ceₓ(FeLaNdZr)₁₋ₓO_{2-y} systems similarly showed large variations in surface area (57-135 and 43-138 m²/g, respectively). On the other hand, surface areas of the Ceₓ(LaMnNdZr)₁₋ₓO_{2-y} and Ceₓ(AlPrYZr)₁₋ₓO_{2-y} samples showed a much lower dependence on cerium content. Ceₓ(LaMnNdZr)₁₋ₓO_{2-y} sample surface areas only varied by 33 m²/g (from 100-133 m²/g). Surprisingly, surface areas for the Ceₓ(AlPrYZr)₁₋ₓO_{2-y} system varied by only 17 m²/g (from 121-138 m²/g). Al, Pr, Y, and Zr constituents are thus able to stabilize a high surface area Ce-based fluorite lattice, even when Ce concentration is highly dilute for such a crystal structure. Overall, the multi-cationic oxides produced through the sol-gel method achieve far higher surface area than those produced by solid-state methods reported here and in other HEO literature. See H. Chen et al., J. Mater. Chem. A 6(24), 11129 (2018); and F. Okejiri et al., ChemSusChem 13(1), 111 (2020).

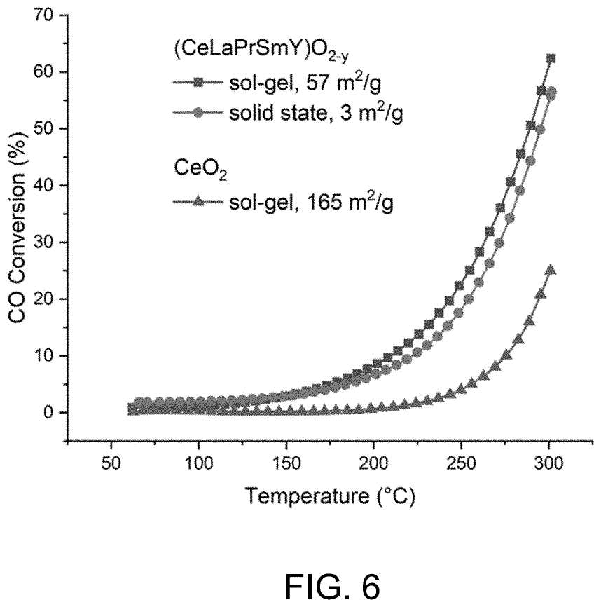

HEO samples were tested in the CO oxidation reaction to measure their catalytic activity. FIG. 6 shows the CO oxidation reaction of (CeLaPrSmY)O_{2-y} synthesized through both sol-gel and solid-state methods, as well as CeO₂ synthesized through sol-gel method. Both HEOs had improved activity compared to undoped ceria, as expected. Further, the higher surface area of the sol-gel HEO produced an improvement in activity compared to the solid-state HEO sample. However, this improvement was relatively small considering the large difference in surface areas of these HEOs. Incorporation of small amounts of rare earth cations enhanced catalytic properties in previous studies, yet high concentrations were detrimental, which could explain the low activity of equimolar HEOs. See J. Guo et al., J. Alloys Compd. 621, 104 (2015); and R. Ran et al., J. Rare Earths 29(11), 1053 (2011). However, Ce_{0.5}(LaPrSmY)_{0.5}O_{2-y} and Ce_{0.8}(LaPrSmY)_{0.2}O_{2-y} samples, with reduced dopant concentrations, also were found to have low intrinsic activity. Catalytic activity of doped ceria was previously found to be dopant dependent. See C. Riley et al., Appl. Catal. B 264, 118547 (2020). Similarly, low activity was found for all Ceₓ(AlPrYZr)₁₋ₓO_{2-y} and Ceₓ(LaNdPrSm)₁₋ₓO_{2-y} samples.

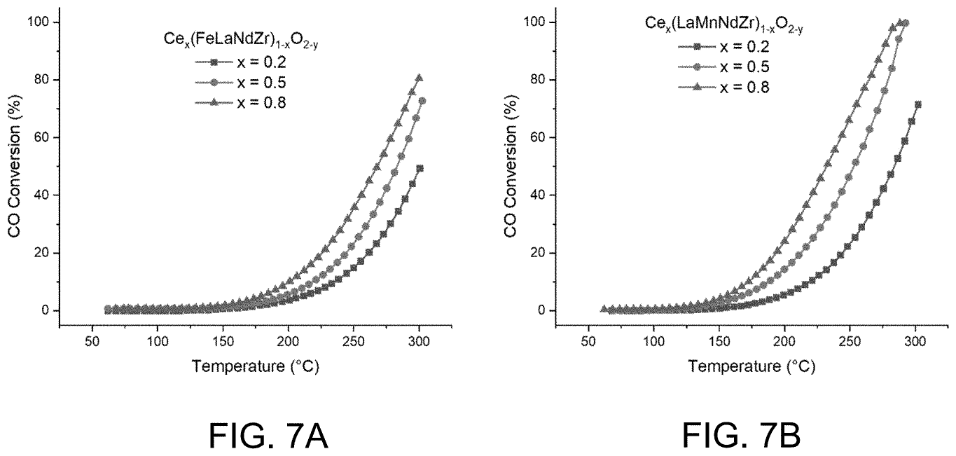

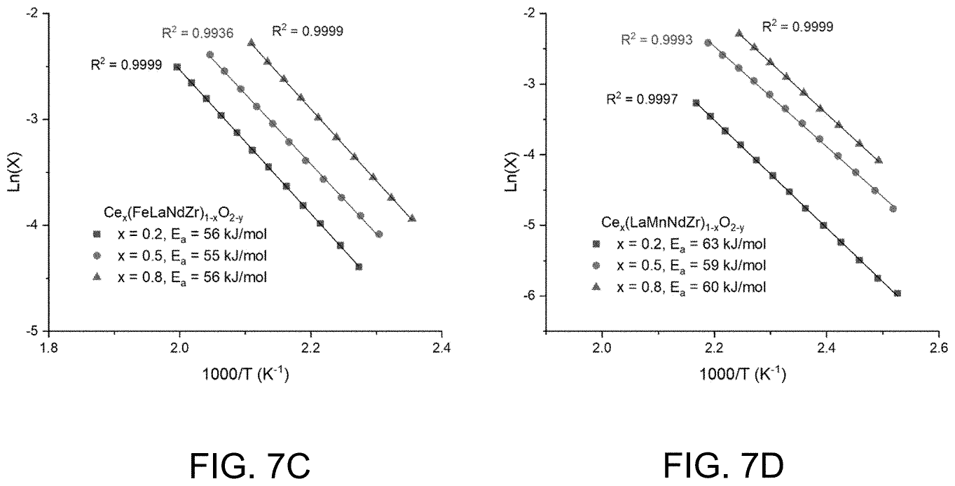

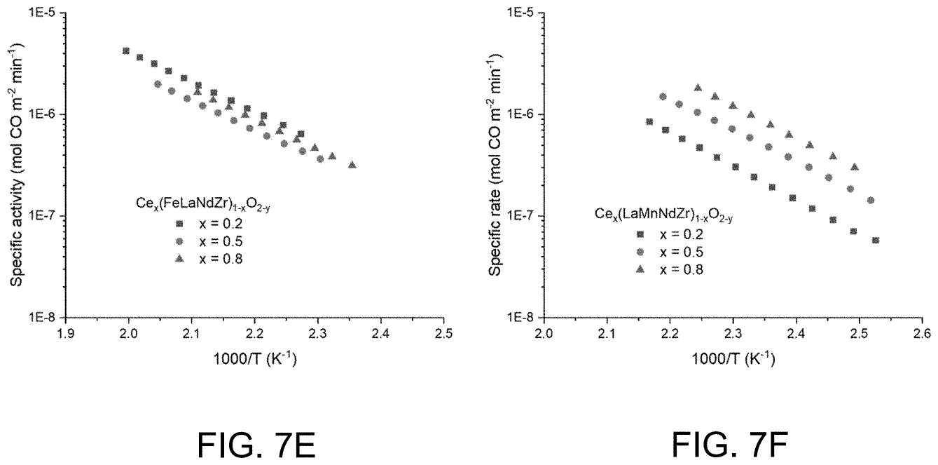

To improve catalytic activity, Fe and Mn cations were incorporated into the HEO, both of which enhanced activity, as shown in FIGS. 7A and 7B. As seen in similar materials, Mn cation was more effective than Fe, and activity improved with increasing cerium content for both sample sets. See C. Riley et al., Appl. Catal. B 264, 118547 (2020); O. H. Laguna et al., Appl. Catal. B 106(3-4), 621 (2011); and J. Wang et al., J. Solgel Sci. Technol. 58(1), 259 (2010). Thus, the most active sample was Ce_{0.8}(LaMnNdZr)_{0.2}O_{2-y}. Arrhenius plots for Mn and Fe-containing HEOs are shown in FIGS. 7C and 7D. Apparent activation energies (Eₐ) for Ceₓ(LaMnNdZr)₁₋ₓO_{2-y} samples range from 59-63 kJ/mol, and those for Ceₓ(FeLaNdZr)₁₋ₓO_{2-y} are 55-56 kJ/mol. These values are consistent with previous Eₐ values for ceria-based CO oxidation catalysts. See H. Chen et al., Appl. Catal. B 276, 119155 (2020); and C. Riley et al., Appl. Catal. B 264, 118547 (2020). Consistency in Eₐ among the HEOs further indicates that a similar reaction mechanism occurs for the samples, regardless of Ce content or other cations.

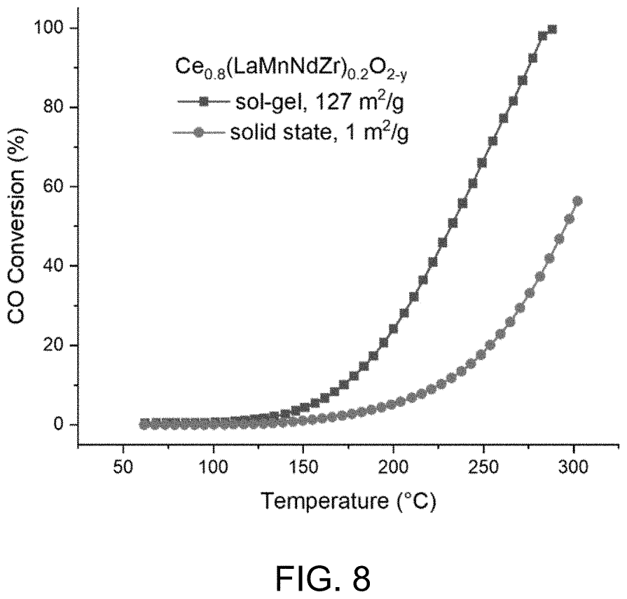

Having produced an active HEO via sol-gel synthesis, a sample of the same composition was made through the solid-state method for comparison. Specific surface areas of the sol-gel and solid-state synthesized Ce_{0.8}(LaMnNdZr)_{0.2}O_{2-y} samples were vastly different, 127 and 1 m²/g, respectively. The sol-gel sample was significantly more active than the solid-state sample for the composition Ce_{0.8}(LaMnNdZr)_{0.2}O_{2-y}, as shown in FIG. 8. This result demonstrates the catalytic benefit of using a low-temperature sol-gel synthesis to produce samples with engineered nanoscale architecture, yielding high surface area. It further demonstrates that HEO composition can be engineered to yield catalytic activity through first row transition metal cations, rather than addition of PGMs.

Structural characterization results were used to analyze trends in catalytic activity. Reaction rates were normalized to surface area for Mn and Fe-containing sol-gel HEOs. Specific rates for the Ceₓ(FeLaNdZr)₁₋ₓO_{2-y} sol-gel samples are quite similar, indicating that surface area is a good descriptor of catalytic activity for these samples, as shown in FIG. 7E. Specific rates for the Ceₓ(LaMnNdZr)₁₋ₓO_{2-y} samples, however, were less similar, as shown in FIG. 7F. The higher surface area did not always translate into higher activity for other sol-gel HEOs. For instance, as shown in FIG. 6, the surface area of the (CeLaPrSmY)O_{2-y} sample made via sol-gel method was over a magnitude greater than that made through solid-state synthesis, yet the CO oxidation activity is only slightly higher. Additionally, other HEOs had higher surface area than Ce_{0.8}(LaMnNdZr)_{0.2}O_{2-y} (the most active sample) but showed low activity, indicating that other properties of the HEOs strongly influence catalytic performance.

Because it is well known that oxidative ceria catalysts operate using the Mars van Krevelen (MvK) mechanism, select HEOs were characterized using thermogravimetric analysis (TGA) to measure oxygen mobility and storage capacity. For the less reactive HEOs, such as (CeLaPrSmY)O_{2-y}, these results showed that the amount of oxygen readily released from the (CeLaPrSmY)O_{2-y} samples is only slightly improved by using the sol-gel method as compared to solid-state synthesis, despite a large difference in the sample surface areas. As shown in Table II, Oxygen Storage Capacity (OSC) of (CeLaPrSmY)O_{2-y} HEOs was relatively low, which mirrors catalytic performance of these samples, and the O₂ uptake of these samples during re-oxidation was substantially less than was emitted during reduction. Therefore, it can be concluded that CO oxidation over these less reactive samples was limited by their relatively poor oxygen mobility and storage capacity, which originates from poor cation selection. In contrast, OSC values were significantly higher for the high performing HEOs, such as sol-gel derived Ce_{0.8}(FeLaNdZr)_{0.2}O_{2-y} and Ce_{0.8}(LaMnNdZr)_{0.2}O_{2-y} (593 and 945 μmol O₂ uptake/mole HEO). These results emphasize the importance of identifying the correct cations in the HEO design. With the correct cations selected for the HEO composition, the benefit of the high surface area, nanoscale architecture of low temperature sol-gel synthesis can be realized, which yielded over a 6-fold increase in OSC among Ce_{0.8}(LaMnNdZr)_{0.2}O_{2-y} samples.

TABLE II
Oxygen storage capacity of select HEO samples.

| | | O₂ lost | O₂ gained |
|---|---|---|---|
| | | during | during |
| | | reduction | reoxidation |
| | Synthesis | (μmol O₂/mol | (μmol O₂/mol |
| Sol-gel sample | technique | HEO) | HEO) |
| (CeLaPrSmY)O_{2-y} | Sol-gel | 434 | 174 |
| (CeLaPrSmY)O_{2-y} | Solid-state | 354 | 274 |
| Ce_{0.8}(FeLaNdZr)_{0.2}O_{2-y} | Sol-gel | 628 | 593 |
| Ce_{0.8}(LaMnNdZr)_{0.2}O_{2-y} | Sol-gel | 1068 | 945 |
| Ce_{0.8}(LaMnNdZr)_{0.2}O_{2-y} | Solid-state | 179 | 146 |

The above discussion demonstrates the utility of the multi-cation concept in HEOs for tuning surface area, OSC, and catalytic activity. Cation inclusion can also improve thermal stability. To evaluate this property, select samples were aged at 800° C. for 8 hours in air and subsequently measured in BET for surface area loss. The thermal stability of sol-gel HEOs was compared to that of Mn- and Fe-doped ceria samples from a previous study, which were made using the same technique. See C. Riley et al., Appl. Catal. B 264, 118547 (2020). According to the results in Table III, the same cations that improved activity (namely, Fe and Mn) also lowered thermal stability, since the surface areas of aged Ce_{0.9}Mn_{0.1}O_{2-y} and Ce_{0.9}Fe_{0.1}O_{2-y} samples were lower than for undoped ceria. Fe and Mn are known to act as sintering aids for ceria at elevated temperature. See L. Wu et al., Cryst. Growth Des. 17(2), 446 (2017); Z. Tianshu et al., J. Mater. Process. Technol. 113(1-3), 463 (2001); and T. S. Zhang et al., Mater. Sci. Eng. B 103(2), 177 (2003). However, almost all of the HEO samples tested were more stable than the previous constructs. In fact, all HEOs with a nominal 80 at % Ce content retained higher surface areas after aging than pure ceria and ceria doped with only Mn or Fe. Similar stabilizing effects of these cations (La, Pr, Sm, Y, Zr) within ceria solid solutions are indicated in the literature. See B. Zhao et al., J. Environ. Chem. Eng. 1(3), 534 (2013); P. Li et al., Catal. Today 327, 90 (2019); and G. Jiaxiu et al., Appl. Surf. Sci. 273, 527 (2013).

TABLE III
Surface area of select aged sol-gel samples.

| | Specific surface | Surface area |
|---|---|---|
| | area after aging | retained after |
| Sol-gel sample | (m²/g) | aging (%) |
| CeO₂ | 12 | 7 |
| Ce_{0.9}Fe_{0.1}O_{2-y} | 3 | 2 |
| Ce_{0.9}Mn_{0.1}O_{2-y} | 4 | 2 |
| Ce_{0.5}(LaZrNdFe)_{0.5}O_{2-y} | 9 | 9 |
| Ce_{0.8}(LaZrNdFe)_{0.8}O_{2-y} | 39 | 28 |
| Ce_{0.5}(LaZrNdMn)_{0.5}O_{2-y} | 40 | 30 |
| Ce_{0.8}(LaZrNdMn)_{0.2}O_{2-y} | 46 | 36 |

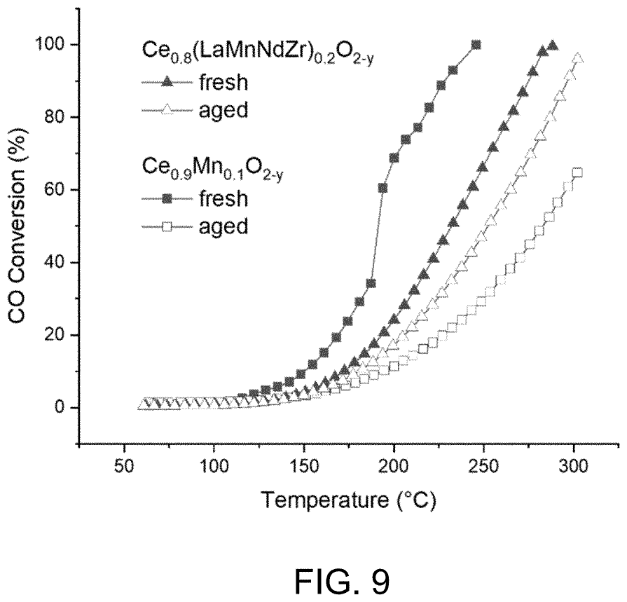

FIG. 9 demonstrates that this improved stability translates into better catalytic activity after aging. Mn-doped ceria deactivates significantly during aging, with an increase in T₅₀ (the temperature needed for 50% conversion of CO) close to 100° C. However, aging effects of the Ce_{0.8}(LaMnNdZr)_{0.2}O_{2-y} sample are much less severe, with a shift in T₅₀ of approximately 25° C. In sum, first row transition metal cations enhance catalytic activity at the expense of thermal stability. Rare earth cations, which stabilize the ceria structure, are important to prevent thermal deactivation. Therefore, the HEO concept of multi-cationic oxides leverages the simultaneous functionalities imparted by specific constituent elements to collectively yield robust catalysts.

The present invention has been described as synthesis of high surface area, high entropy oxides. It will be understood that the above description is merely illustrative of the applications of the principles of the present invention, the scope of which is to be determined by the claims viewed in light of the specification. Other variants and modifications of the invention will be apparent to those of skill in the art.

We claim:

1. A high surface area, high entropy oxide, comprising:
a plurality of metal cations with oxygen anions in a single-phase fluorite lattice structure, wherein at least one of the metal cations comprises a first-row transition metal cation.

2. The high surface area, high entropy oxide of claim 1, wherein the plurality of metal cations comprises five or more metal cations.

3. The high surface area, high entropy oxide of claim 1, wherein the plurality of metal cations comprises Ce.

4. The high surface area, high entropy oxide of claim 3, wherein the high surface area, high entropy oxide comprises between 20-80 at % Ce.

5. The high surface area, high entropy oxide of claim 3, wherein the plurality of metal cations further comprises Al, La, Nd, Pr, Sm, Y, or Zr.

6. The high surface area, high entropy oxide of claim 1, wherein the at least one first-row transition metal cation comprises Fe or Mn.

7. The high surface area, high entropy oxide of claim 1, wherein the high surface area, high entropy oxide is synthesized using a sol-gel method.

8. The high surface area, high entropy oxide of claim 1, wherein the high surface area, high entropy oxide has a specific surface area of 6 m²/g or greater.

9. The high surface area, high entropy oxide of claim 1, wherein the high surface area, high entropy oxide has an oxygen storage capacity of 174 mmol O₂/mol high energy oxide or greater.

10. The high surface area, high entropy oxide of claim 1, wherein the high surface area, high entropy oxide has a specific activity of 1E-7 mol CO m⁻² min⁻¹ at 125° C. of greater.

11. A method for the sol-gel synthesis of a high surface area, high entropy oxide, comprising:
dissolving a polymeric complexing agent in water, thereby providing an aqueous solution,
dissolving a plurality of metal salts in the aqueous solution, thereby complexing the dissolved metal cations with a functional group of the polymeric complexing agent in the aqueous solution,
drying the aqueous solution to form a gel, and
calcining the gel in an oxygen atmosphere to provide the high surface area, high entropy oxide in a single-phase fluorite lattice structure.

12. The method of claim 11, wherein the polymeric complexing agent comprises polyvinylpyrrolidone.

13. The method of claim 11, wherein the metal salt comprises a metal nitrate.

14. The method of claim 11, wherein the gel is calcined at a temperature of about 500° C.

15. The method of claim 11, wherein the plurality of metal salts comprises a Ce salt.

16. The method of claim 15, wherein the plurality of metal salts further comprises an Al, La, Nd, Pr, Sm, Y, or Zr salt.

17. The method of claim 11, wherein the plurality of metal salts comprises at least one first-row transition metal salt.

18. The method of claim 17, wherein the at least one first-row transition metal salt comprises an Fe or Mn salt.

19. A method for the oxidation of CO, comprising:
providing a high surface area, high entropy oxide, and
exposing the high-surface area, high entropy oxide to gaseous CO, thereby catalyzing the conversion of CO to CO₂.
